(19) United States
(12) Patent Application Publication
(10) Pub. No.: US 2012/0268648 A1
(43) Pub. Date: Oct. 25, 2012

(54) ADAPTIVE LENS MODULE AND IMAGE CAPTURING APPARATUS

(75) Inventor: Chih-Yi YANG, Taipei City (TW)

(73) Assignee: Lumos Technology Co., Ltd.

(21) Appl. No.: 13/092,314

(22) Filed: Apr. 22, 2011

(51) Int. Cl. H04N 5/225

(52) U.S. Cl. 348/360; 348/E05.024

(57) ABSTRACT

An adaptive lens module is disclosed for connecting to a camera. The camera has a zooming lens. The adaptive lens module includes a first magnetic unit, an adapter and a lens unit. The first magnetic unit is arranged on the camera. The adapter has a second magnetic unit for detachably connecting to the first magnetic unit, and a through hole for passing through the zooming lens. The lens unit is arranged on the adapter and optical connects with the zooming lens.

### BACKGROUND OF THE INVENTION

1. Field of the Invention

The present invention relates to a lens module, in particularly, to an adaptive lens module for connecting to a digital camera.

2. Description of Related Art

Digital camera has advantages of reviewing images right away after the images were captured and storing the images captured into electronic devices such as computers or other digital storage devices. The digital cameras rapidly replace the traditional film cameras and become the mainstream of the camera market.

The maximum magnification power of the conventional digital camera is in the range of 10× to 20×x, which is merely for usual sight shooting but difficult to perform a high-magnified shooting or a shrunk image shooting. Therefore, a conventional detachable high-magnification lens is used for connecting to the digital camera.

However, a connecting mechanism has to be permanently arranged on the digital camera for connecting the detachable high-magnification lens. Such a connecting mechanism occupies a space on the digital camera and changes the original shape or even affects the convenience of the digital camera.

Therefore, it becomes a major problem that how to provide an adaptive lens module for connecting to the digital camera, which can effectively downsize the connecting mechanism and remain the original shape and convenience of the digital camera.

### SUMMARY OF THE INVENTION

The object of present invention is to provide an adaptive lens module capable of effectively downsizing the connecting mechanism and remaining the original shape and convenience of the digital camera.

For achieving the above-mentioned object, the present invention provides an adaptive lens module for connecting to a camera. The camera has a zooming lens. The adaptive lens module includes a first magnetic unit, an adapter and a lens. The first magnetic unit is arranged on the camera. The adapter has a second magnetic unit magnetically and detachably connected to the first magnetic unit, and a through hole for passing through the zooming lens. The lens unit is connected to the adapter and optical connected with the zooming lens.

The present invention provides another adaptive lens module for connecting to a camera. The adaptive lens module includes a first magnetic unit arranged on the camera, and a lens unit having a second magnetic unit magnetically and detachably connected to the first magnetic unit.

In addition, the present invention provides an image capturing apparatus having the above-mentioned adaptive lens module.

### BRIEF DESCRIPTION OF THE DRAWINGS

FIG. 1 shows a perspective view of an image capturing apparatus according to a first embodiment of the present invention;

FIG. 2 shows a sectional view of the image capturing apparatus in FIG. 1;

FIG. 3 shows an exploded view of an image capturing apparatus according to a second embodiment of the present invention; and

FIG. 4 shows an exploded view of an image capturing apparatus according to a third embodiment of the present invention.

### DETAILED DESCRIPTION OF THE INVENTION

A detailed description of the present invention will be made with reference to the accompanying drawings.

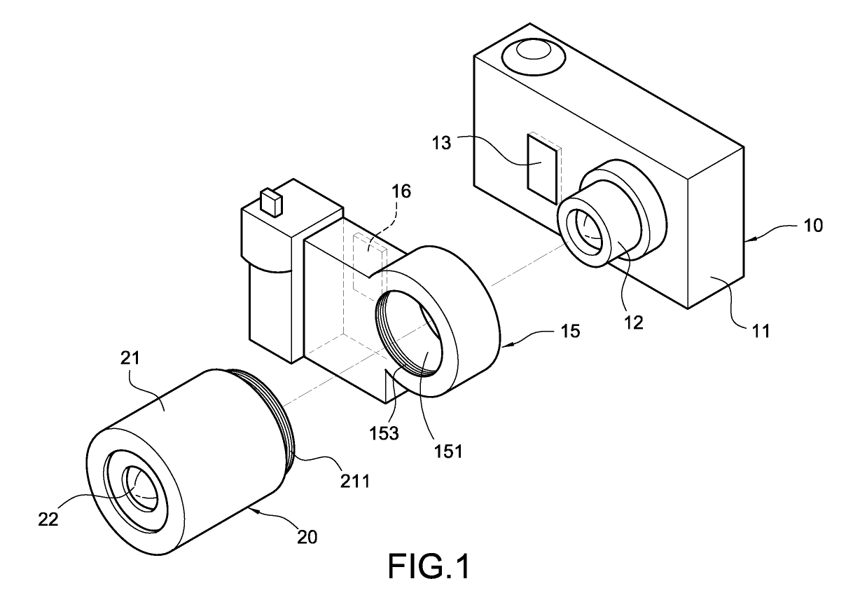

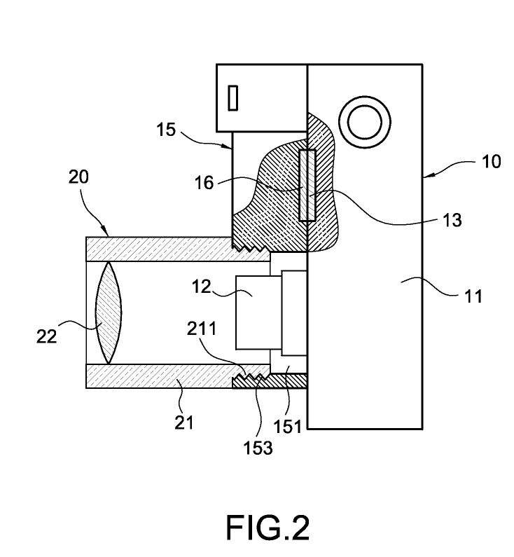

FIG. 1 and FIG. 2 show an image capturing apparatus according to the first embodiment of the present invention. The image capturing apparatus is used for capturing images. The image capturing apparatus mainly includes a camera 10 and an adaptive lens module. The adaptive lens module includes a first magnetic unit 13, an adapter 15 and a lens unit 20.

The camera 10 can be used for capturing images. In this embodiment, the camera 10 is, for example, a compact digital camera. The camera 10 has a main body 11, and a zooming lens 12 extending from the main body 11. The first magnetic unit 13 is arranged on a side of the main body 11. More specifically, the first magnetic unit 13 is arranged on the same side where the zooming lens 12 is arranged.

The adaptor 15 has a second magnetic unit 16 for detachably connecting to the first magnetic unit 13 by magnetic force. Further, the adapter 15 has a through hole 151 for passing through the zooming lens passes 12. The through hole 151 has a threaded portion 153 away from the camera 10. More specifically, the first magnetic unit 13 is a permanent magnet. The second magnetic unit 16 is also a permanent magnet having opposite polarity to the first magnetic unit 13. The first magnetic unit 13 can be arranged on a surface of the camera 10, or can be embedded in the camera 10.

The lens unit 20 is connected to the adapter 15 and optical connected with the zooming lens 12 for capturing images. The lens unit 20 includes a barrel 21 and at least one lens 22 arranged inside the barrel 21. The barrel 21 is connected to the adapter 15. The barrel 21 has a threaded portion 211 for connecting to the threaded portion 153 of the adapter 15.

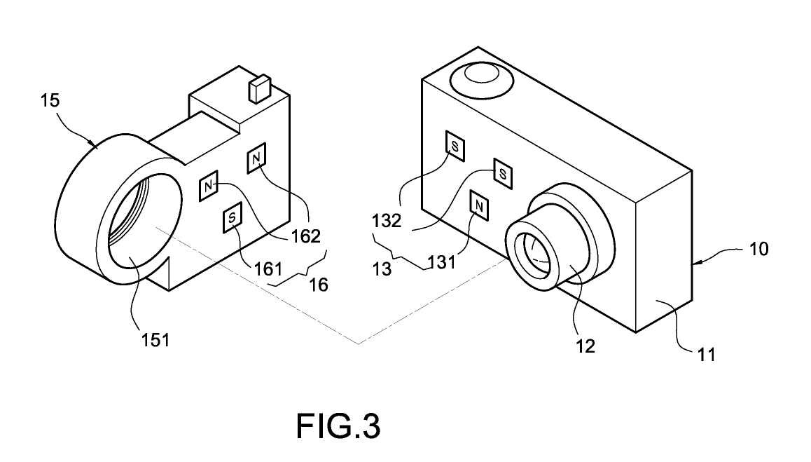

FIG. 3 shows an image capturing apparatus according to the second embodiment of the present invention, which is similar to the first embodiment. The difference between the first and second embodiments is that the first magnetic unit 13 has a plurality of magnets in which at least one magnet has different polarity with respect to the others, and the second magnetic unit 16 also has a plurality magnets in which at least one magnet has different polarity with respect to the others.

In this embodiment, the first magnetic unit 13 has three magnets arranged in a triangular manner. The magnet 131 located below has opposite polarity to the other two magnets 132 above. Correspondingly, the second magnetic unit 16 has three magnets arranged in a triangular manner as well. The magnet 161 located below has opposite polarity to the other two magnets 162 above. The magnet 131 has different polarity to the magnet 161. The magnets 132 have different polarity to the magnets 162.

When approaching the adapter 15 to the camera 10, the first magnetic unit 13 can be correspondingly attracted by the second magnetic unit 16 so as to magnetically connect with each other. Beside that, because of the different polarities of the permanent magnets in either the first magnetic unit 13 or the second magnetic unit 16, the first magnetic unit 13 can be more accurately self-aligned to the second magnetic unit 16.

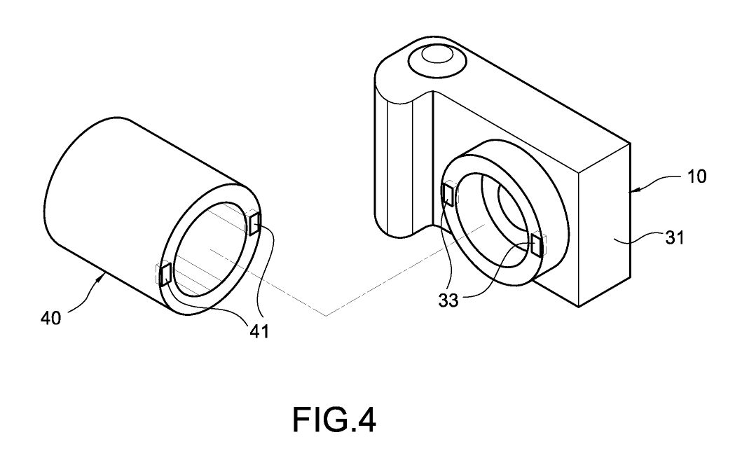

FIG. 4 shows an image capturing apparatus according to the third embodiment of the present invention, which is similar to the first embodiment. The difference between the first and third embodiments is that the camera 10 is a digital single lens reflex camera (DSLR). Besides, this embodiment does not need the adapter for connecting the lens unit 20 to the camera 10. The DSLR does not have a zooming lens. The first magnetic unit 33 is arranged on the main body 31 of the camera 10. The first magnetic unit 33 has a plurality of magnets in which at least one magnet has different polarity with respect to the others. The second magnetic unit 41 is arranged on an end of the lens unit 40 near the main body 31. The second magnetic unit 41 also has a plurality magnets in which at least one magnet has different polarity with respect to the others. When approaching the lens unit 40 to the camera 10, the first magnetic unit 33 can be correspondingly attracted by the second magnetic unit 41 so as to magnetically connect the lens unit 40 to the camera 10.

In conclusion, the first magnetic unit provided on the camera can be magnetically connected to the second magnetic unit of the adaptive lens module. It provides a convenient approach to rapidly connect the adapter or the lens unit to the camera. Because the only connecting mechanism needed to be arranged on the camera is the low-profile first magnetic unit, the original shape and convenience of the digital camera can be remained.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An adaptive lens module for connecting to a camera, the camera having a zooming lens, the adaptive lens module comprising:
a first magnetic unit arranged on the camera;
an adapter having a second magnetic unit magnetically and detachably connected to the first magnetic unit, and a through hole for passing through the zooming lens; and
a lens unit connected to the adapter and optical connected with the zooming lens.

2. The adaptive lens module as claim 1, wherein the first magnetic unit is a permanent magnet and the second magnetic unit is another permanent magnet having opposite polarity to the first magnetic unit.

3. The adaptive lens module as claim 1, wherein the first magnetic unit has a plurality of magnets in which at least one magnet has different polarity with respect to the others, and the second magnetic unit has a plurality magnets in which at least one magnet has different polarity with respect to the others.

4. The adaptive lens module as claim 3, wherein the first magnetic unit has three magnets arranged in a triangular manner and the second magnetic unit has three magnets arranged in a triangular manner.

5. An adaptive lens module for connecting to a camera, the adaptive lens module comprising:
a first magnetic unit arranged on the camera; and
a lens unit having a second magnetic unit magnetically and detachably connected to the first magnetic unit.

6. The adaptive lens module as claim 5, wherein the first magnetic unit is a permanent magnet and the second magnetic unit is another permanent magnet having opposite polarity to the first magnetic unit.

7. The adaptive lens module as claim 5, wherein the first magnetic unit has a plurality of magnets in which at least one magnet has different polarity with respect to the others, and the second magnetic unit has a plurality magnets in which at least one magnet has different polarity with respect to the others.

8. The adaptive lens module as claim 7, wherein the first magnetic unit has three magnets arranged in a triangular manner and the second magnetic unit has three magnets arranged in a triangular manner.

9. An image capturing apparatus comprising:
a camera having a zooming lens and a first magnetic unit arranged thereon;
an adapter having a second magnetic unit magnetically and detachably connected to the first magnetic unit, and a through hole for passing through the zooming lens; and
a lens unit connected to the adapter and optical connected with the zooming lens.

10. The image capturing apparatus as claim 9, wherein the first magnetic unit is a permanent magnet and the second magnetic unit is another permanent magnet having opposite polarity to the first magnetic unit.

11. The image capturing apparatus as claim 9, wherein the first magnetic unit has a plurality of magnets in which at least one magnet has different polarity with respect to the others, and the second magnetic unit has a plurality magnets in which at least one magnet has different polarity with respect to the others.

12. The image capturing apparatus as claim 11, wherein the first magnetic unit has three magnets arranged in a triangular manner and the second magnetic unit has three magnets arranged in a triangular manner.

13. An image capturing apparatus comprising:
a camera having a first magnetic unit arranged thereon; and
a lens unit having a second magnetic unit magnetically and detachably connected to the first magnetic unit.

14. The image capturing apparatus as claim 13, wherein the first magnetic unit is a permanent magnet and the second magnetic unit is another permanent magnet having opposite polarity to the first magnetic unit.

15. The image capturing apparatus as claim 13, wherein the first magnetic unit has a plurality of magnets in which at least one magnet has different polarity with respect to the others, and the second magnetic unit has a plurality magnets in which at least one magnet has different polarity with respect to the others.

16. The image capturing apparatus as claim 15, wherein the first magnetic unit has three magnets arranged in a triangular manner and the second magnetic unit has three magnets arranged in a triangular manner.
